(19) United States
(12) Patent Application Publication
(10) Pub. No.: US 2015/0098233 A1
(43) Pub. Date: Apr. 9, 2015

(54) LIGHT GUIDING DEVICE FOR VEHICLE HEADLIGHTS

(71) Applicant: Chen-Wei HSU, Tainan (TW)

(72) Inventor: Chen-Wei HSU, Tainan (TW)

(21) Appl. No.: 14/243,891

(22) Filed: Apr. 3, 2014

(30) Foreign Application Priority Data
Oct. 4, 2013 (TW) 102218605

(51) Int. Cl. F21S 8/10

(52) U.S. Cl. CPC F21S 48/115; F21S 48/1233
USPC 362/509

(57) ABSTRACT

A light guiding device for a headlight includes a casing, a light guiding tube and a cover. The light guiding tube is connected to the front of the casing and the cover is connected to the casing. The light guiding tube is composed of a silicone tube and two Light Emitting Diode tubes. The silicone tube is made by silicone which allows light beams to evenly pass. The silicone tube has a flat surface formed on an underside thereof and a curved surface formed on the top thereof The silicone tube has a room defined therein and at least one passage is defined through the silicone tube. The two Light Emitting Diode tubes each have multiple Light Emitting Diodes and are located in the room. The light beams generated from the Light Emitting Diodes evenly pass through the silicone tube to provide illumination and warning features.

### BACKGROUND OF THE INVENTION

1. Fields of the Invention

The present invention relates to a light guiding device, and more particularly, to a light guiding device of a vehicle headlight so as to guide the light evenly.

2. Descriptions of Related Art

As shown in FIG. 1, the conventional headlight 1 is composed of a casing 10 and a cover 11, wherein the light bulb 12 is connected to the casing 10 in order to generate light beams passing through the cover 11 to illuminate the road in front of the vehicle or to provide warning signals. Most of the headlights have a LED tube 13 composed of multiple LEDs 14 generating light beams to assist the illumination of the light bulb 12. However, the LEDs 14 emit the light beams directly toward the coming drivers or pedestrians, the drivers of the coming vehicles or the pedestrians cannot see the road conditions and this affects the road safety. The LEDs 14 are grouped by three so that when one of the three LEDs 14 is functionless, the whole three LEDs 14 cannot function properly. Therefore, the LED tube 13 cannot evenly generate light.

There is another headlight which has a light guiding device. There are two light guiding tubes and each light guiding tubes has an LED connected to each of two ends thereof. The light beams generated by the LEDs reach the inside of the light guiding tubes to achieve the purpose of light guidance. However, the two ends of the light guiding tubes are brighter than the rest part of the light guiding tubes. This

The present invention intends to provide a light guiding device for a headlight and the light guiding device improves the shortcomings mentioned above.

### SUMMARY OF THE INVENTION

The present invention relates to a light guiding device for a headlight and comprises a casing having at least one light source connected thereto. Multiple slots are defined in the outer periphery of the casing and a hole is defined through the casing. A light guiding tube is connected to the front of the casing and composed of a silicone tube and two Light Emitting Diode tubes. The silicone tube is made by silicone which allows light beams to evenly pass. The silicone tube has a flat surface formed on the underside thereof and a curved surface is formed on the top thereof. The silicone tube has a room defined therein. The silicone tube has at least one passage defined therethrough. The two Light Emitting Diode tubes each have multiple Light Emitting Diodes connected thereto. Wires extend from each of the two Light Emitting Diode tubes and through the hole of the casing. The two Light Emitting Diode tubes are located in the room. A cover is connected to the casing and has multiple protrusions which are engaged with the slots of the casing.

Preferably, the casing has a recess defined in the front thereof and the light guiding tube is engaged with the recesses.

Preferably, adhesive is applied to the flat surface of the silicone tube. The light guiding tube is fixed to the front of the casing by the adhesive on the flat surface.

Preferably, the curved surface of the silicone tube has at least one notch.

Preferably, the silicone tube has multiple ridges on two sides thereof

Preferably, the room of the silicone tube has multiple grooves defined in the inside thereof. The grooves are located corresponding to the curved surface.

Preferably, a corner member is mounted to the wires and covers up the wires of each of the Light Emitting Diode tubes.

The primary object of the present invention is to provide a light guiding device for a headlight, and the light guiding device can be easily bent to form a shape that is cooperated with the shape of different headlights.

Another object of the present invention is to provide a light guiding device for a headlight, and the light guiding device delivers the light beams evenly.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the conventional light guiding device;

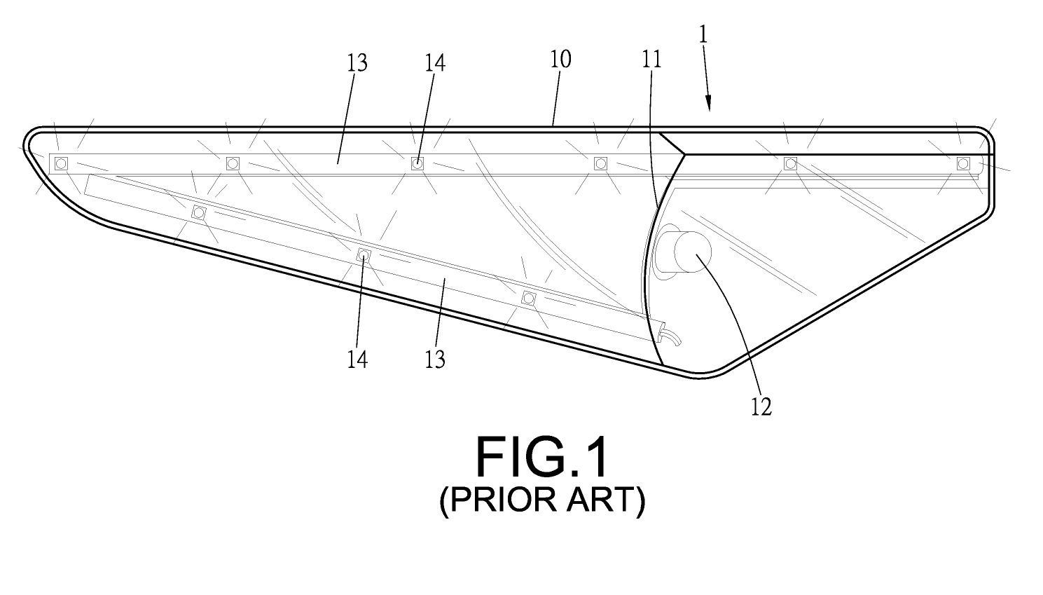

FIG. 2 is an exploded view of the light guiding device of the present invention;

FIG. 3 is a cross sectional view of the light guiding device of the present invention;

FIG. 4 is a perspective view to show the light guiding device of the present invention, and

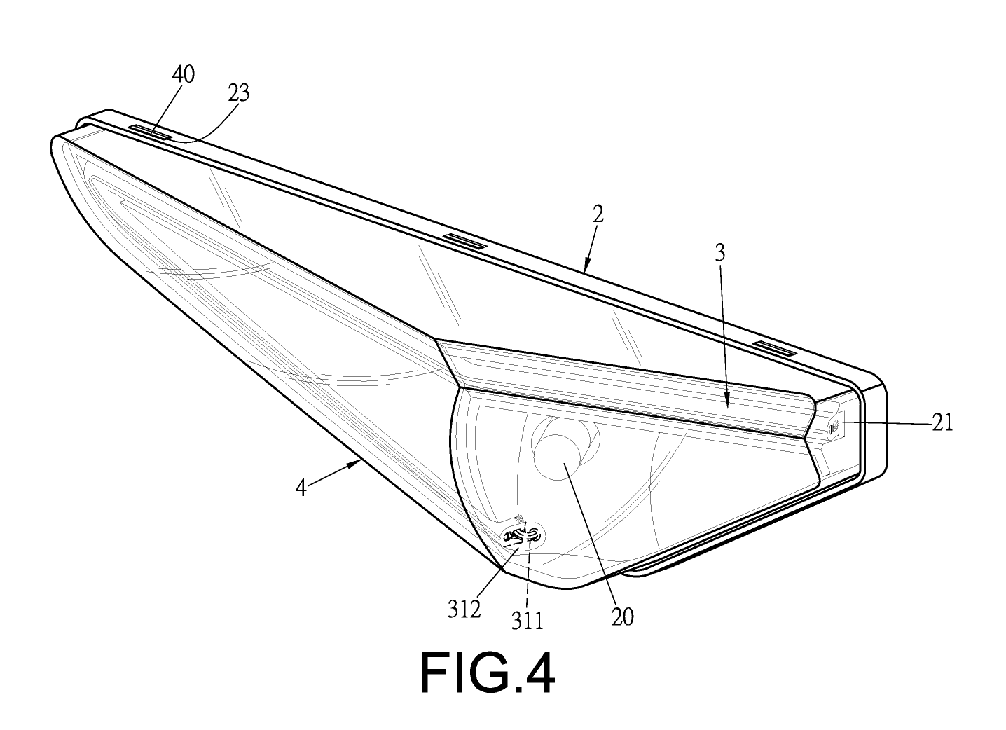

FIG. 5 is a perspective view to show the operation status of the light guiding device of the present invention.

### DETAILED DESCRIPTION OF THE PREFERRED EMBODIMENT

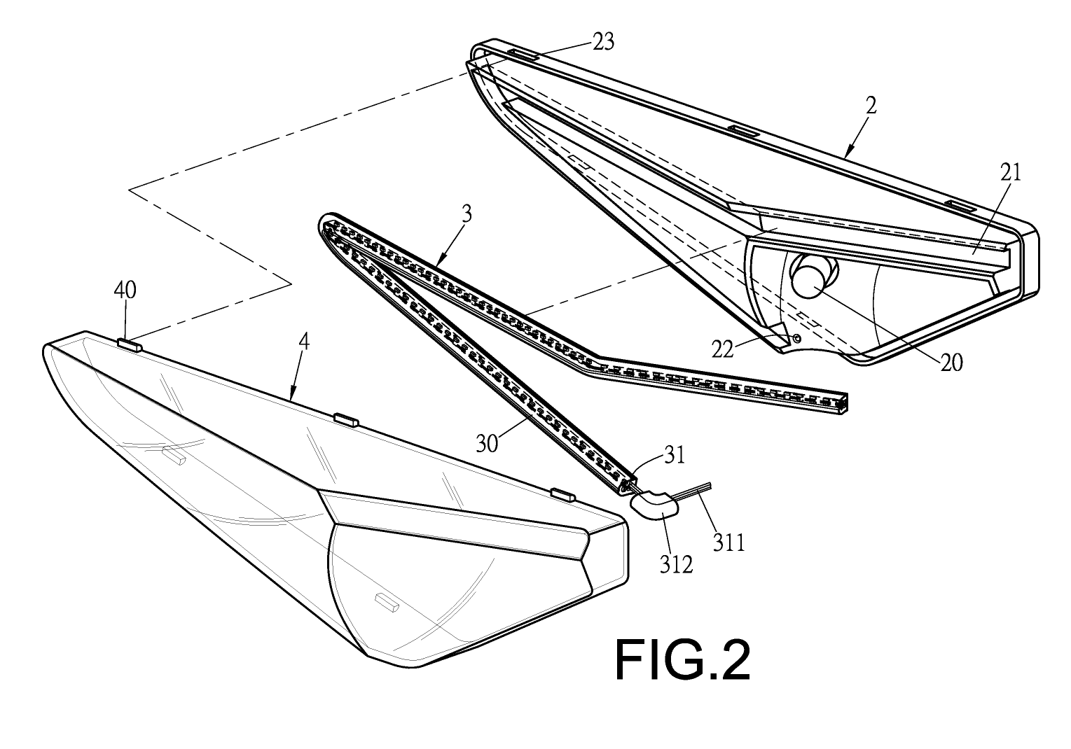

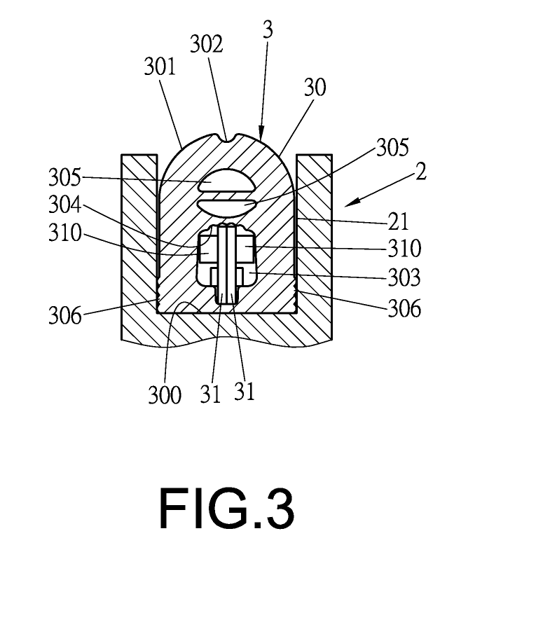

Referring to FIGS. 2 to 3, the light guiding device for a headlight of the present invention comprises a casing 2, a light guiding tube 3 and a cover 4. The casing 2 has at least one light source 20 connected thereto. The casing 2 has recesses 21 defined in the front thereof. Multiple slots 23 are defined in the outer periphery of the casing 10 and a hole 22 is defined through the casing 2.

The light guiding tube 3 is engaged with the recess 21 of the casing 2. The light guiding tube 3 comprises a silicone tube and two Light Emitting Diode tubes 31 as shown in FIG. 3, wherein the silicone tube 30 is made by silicone which allows light beams to evenly pass. The silicone tube 30 having a flat surface 300 formed on the underside thereof and a curved surface 301 is formed on the top of the silicone tube 30. The curved surface 301 of the silicone tube 30 has at least one notch 302. The silicone tube 30 has a room 303 defined therein so that the two Light Emitting Diode tubes 31 are located in the room 303. The room 303 of the silicone tube 30 has multiple grooves 304 defined in the inside thereof, the grooves 304 are located corresponding to the curved surface 301. The silicone tube 30 has at least one passage 305 defined therethrough. The silicone tube 30 has multiple ridges 306 on two sides thereof. The two Light Emitting Diode tubes 31 are located in the room 303 of the silicone tube 3. Each Light Emitting Diode tube 31 has multiple Light Emitting Diodes 310 connected thereto. The Light Emitting Diodes 310 on each of the two Light Emitting Diode tubes 31 are grouped by three. Wires 311 extend from each of the two Light Emitting Diode tubes 31 and extend through the hole 22 of the casing 2. A corner member 312 is mounted to the wires 311 and covers up the wires 311 of each of the Light Emitting Diode tubes 31.

The cover 11 is connected to the casing 2 and has multiple protrusions 40 which are engaged with the slots 23 of the casing 2. The cover 11 allows the light beams to pass therethrough.

When assembling the light guiding device to the headlight, the light guiding tube 3 is engaged with the recess 21 of the casing 2. The ridges 306 on the silicone tube 30 snugly touch the inside of the recess 21 to position the light guiding tube 3 in the recess 21 of the casing 2. Adhesive is applied to the flat surface 300 of the silicone tube 30 so as to fix the light guiding tube 3 in the recess 21 at the front of the casing 2. The wires 311 of the Light Emitting Diode tubes 31 extend through the hole 22 of the casing 2, and the cover 4 is connected to the casing 2 by engaging the protrusions 40 with the slots 23. The corner member 312 covers the wires 311 of the end of the light guiding tube 3 and the hole 22 of the casing 2.

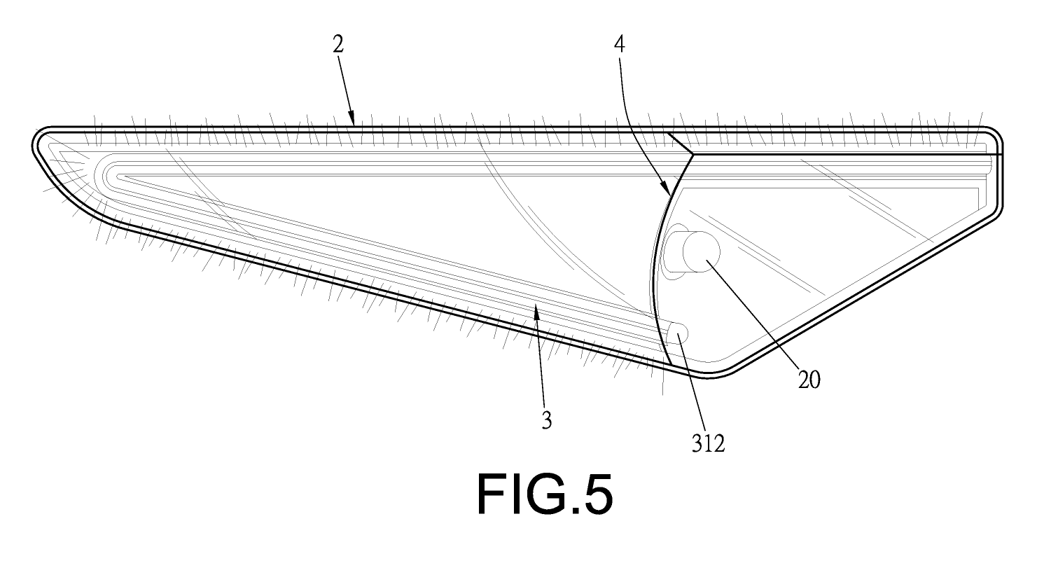

As shown in FIG. 5, the Light Emitting Diodes 310 on each of the two Light Emitting Diode tubes 31 generate light beams which pass through the silicone tube 30 which evenly delivers the light beams so that the light beams will not too bright to affect the coming drivers or pedestrians. The Light Emitting Diode tube 31 has multiple Light Emitting Diodes 310 connected thereto and the Light Emitting Diodes 310 on each of the two Light Emitting Diode tubes 31 are grouped by three. Although when one of the Light Emitting Diodes 310 in one group is functionless, all of the three Light Emitting Diodes 310 will be functionless, thanks to the silicone tube 30 of the present invention, the light beams from the rest of the Light Emitting Diodes 310 on the Light Emitting Diode tubes 31 still provide even illumination or warming features. When the light beams from the Light Emitting Diodes 310 on the Light Emitting Diode tubes 31 reach the notch 302 in the top of the silicone tube 30, the light beams are evenly displayed. The room 303 of the silicone tube 30 has multiple grooves 304 in the inside thereof, and the grooves 304 are located corresponding to the curved surface 301, so that the light beams are evenly refracted by the grooves 304. Furthermore, the silicone tube 30 is flexible and can be easily bent to form a desired shape, and the passages 305 provide a room for the deformation so that it is easy to bend the silicone tube 30. The silicone tube 30 can be easily cooperated with different types of headlights. The light guiding tube 3 provides illumination and warning features to the headlight. The Light Emitting Diodes 310 on one of the two Light Emitting Diode tubes 31 can be set to generate orange light beams and are simultaneously operated when the turn lights of the vehicle are activated. The Light Emitting Diodes 310 on the other one of the two Light Emitting Diode tubes 31 can be set to generate blue light beams and are connected to the headlights to provide warning features in the night. The light guiding tube 3 can be bent to a desired shape so as to be connected with different casings 2 of headlights, and the colors of the light beams of the Light Emitting Diodes 310 can also be set to meet specific requirements.

While we have shown and described the embodiment in accordance with the present invention, it should be clear to those skilled in the art that further embodiments may be made without departing from the scope of the present invention.

What is claimed is:

1. A light guiding device for a headlight, comprising:
a casing having at least one light source connected thereto, multiple slots defined in an outer periphery of the casing, a hole defined through the casing;
a light guiding tube connected to a front of the casing and being a silicone tube and two Light Emitting Diode tubes, the silicone tube being made by silicone which allows light beams to evenly pass, the silicone tube having a flat surface formed on an underside thereof and a curved surface formed on a top thereof, the silicone tube having a room defined therein, the silicone tube 30 having at least one passage defined therethrough, the two Light Emitting Diode tubes each having multiple Light Emitting Diodes connected thereto, wires extending from each of the two Light Emitting Diode tubes and extending through the hole of the casing, the two Light Emitting Diode tubes located in the room, and
a cover connected to the casing and having multiple protrusions which are engaged with the slots of the casing.

2. The light guiding device as claimed in claim 1, wherein the casing has a recess defined in the front thereof and the light guiding tube is engaged with the recess.

3. The light guiding device as claimed in claim 1, wherein adhesive is applied to the flat surface of the silicone tube, the light guiding tube is fixed to the front of the casing by the adhesive on the flat surface.

4. The light guiding device as claimed in claim 1, wherein the curved surface of the silicone tube has at least one notch.

5. The light guiding device as claimed in claim 1, wherein the silicone tube has multiple ridges on two sides thereof.

6. The light guiding device as claimed in claim 1, wherein the room of the silicone tube has multiple grooves defined in an inside thereof, the grooves are located corresponding to the curved surface.

7. The light guiding device as claimed in claim 1, wherein a corner member is mounted to the wires and covers up the wires of each of the Light Emitting Diode tubes.
